(19) United States
(12) Patent Application Publication
(10) Pub. No.: US 2017/0203723 A1
(43) Pub. Date: Jul. 20, 2017

(54) WIPER SYSTEM FOR A MOTOR VEHICLE WITH SCREEN WASH SYSTEM

(71) Applicant: Valeo Systèmes d'Essuyage, Le Mesnil Saint Denis (FR)

(72) Inventors: Pierre Blanchet, Clairvaux (FR); Eric Gallaud, Poitiers (FR); Jean Jendraszczak, Châtellerault (FR)

(73) Assignee: Valeo Systèmes d'Essuyage, Le Mesnil Saint Denis (FR)

(21) Appl. No.: 15/326,549

(22) PCT Filed: Jun. 22, 2015
(86) PCT No.: PCT/EP2015/063991

§ 371 Date: Jan. 16, 2017

(30) Foreign Application Priority Data
Jul. 17, 2014 (FR) 1456856

(51) Int. Cl. B60S 1/08; B60S 1/58; B60S 1/52; B60S 1/48

(52) U.S. Cl. CPC B60S 1/0803; B60S 1/483; B60S 1/583; B60S 1/52

(57) ABSTRACT

The invention relates to a wiper system (1) for wiping a glazed surface of a motor vehicle having a washer system (3) able to be used in combination with a reservoir (5) containing a washer fluid, said wiper system comprising—a drive motor (7) for driving at least one wiper arm,—a pump (11) intended to be fluidly connected firstly to said reservoir (5) and secondly to at least two spray nozzles at least one of which is able to deliver a jet of fluid to the windshield of a vehicle and at least another of which is able to deliver a jet of fluid to the rear screen of a vehicle, and—a switch (17) having at least a first position for supplying said at least one spray nozzle able to deliver a jet of fluid to the windshield and a second position for supplying said at least one spray nozzle able to deliver a jet of fluid to the rear screen,—the pump (11) being a two-way pump capable of being driven in two opposite directions of rotation to supply one or other of the spray nozzles under the control of said switch (17), characterized in that means (9) for generating electrical control signals which are connected to the drive motor (7) are able to generate electrical control signals that vary according to the angular position of the wiper arm on the glazed surface and in that said two-way pump is supplied when the switch (17) is in the first position via the means (9) of generating electrical control signals which are connected to the drive motor (7) according to the angular position of the wiper arm on the glazed surface.

The present invention relates to a wiper system for a glazed surface of a motor vehicle, such as the windshield and/or the rear window, including a screen wash system.

In the screen wash systems existing at present, there is a known way of arranging for the washing fluid to be spread in only a part of the upward or downward travel of the wiper on the glazed surface.

Thus, screen wash systems for causing spraying to take place when the wiper arm or arms are in predetermined angular areas have already been developed. The document U.S. Pat. No. 4,275,477 describes a first type of screen wash system adapted to interact with the wiper system of a vehicle windshield. The screen wash system is structurally independent of the wiper system, notably in that the nozzles are fixed with respect to the hood of the vehicle. However, the two systems interact closely because some of the washing fluid contained in the cleaning reservoir is drawn up by a pump using electrical information and commands provided by a cam on the drive motor of the wiper arm. More precisely, in this system, it is arranged that no fluid is sprayed when the arm reaches the vicinity of the jet from the nozzle.

The document FR2927295 discloses a system for wiping a glazed surface of a motor vehicle including a screen wash system adapted to be used in association with a reservoir containing a washing fluid.

This wiper system comprises a motor for driving a wiper arm and means for generating electrical control signals linked to the drive motor and adapted to generate electrical control signals (FIXED_STOP, PUMP) which vary according to the angular position of the wiper arm on the glazed surface.

The screen wash system comprises a two-way pump designed to be fluidly connected, on the one hand, to said reservoir, and, on the other hand, to nozzles placed on the wiper arm and capable of delivering at least two jets of fluid on either side of the arm onto the windshield.

The two-way pump may be driven in two opposite directions of rotation to supply one or other of the nozzles alternately, under the control of said means for generating electrical control signals, so as to deliver jets of fluid in front of the arm relative to the direction of wiping.

However, in order to supply a rear window, another pump must be provided, with its own electrical control circuit.

The present invention is intended to propose a simplified wiper system in which a single pump can be used to deliver a jet of fluid to both the windshield and the rear window, while still enabling the jet of fluid to be delivered to the windshield according to the angular position of the wiper arm on the glazed surface.

For this purpose, the invention proposes a wiper system for a glazed surface of a motor vehicle including a screen wash system adapted to be used in association with a reservoir containing a washing fluid, said wiper system comprising:
a motor for driving at least one wiper arm,
a pump designed to be fluidly connected, on the one hand, to said reservoir, and, on the other hand, to at least two nozzles, at least one of which is adapted to deliver a jet of fluid at the windshield of a vehicle and at least another of which is adapted to deliver a jet of fluid at the rear screen of a vehicle, and
a switch having at least a first position for supplying said at least one nozzle adapted to deliver a jet of fluid at the windshield, and a second position for supplying said at least one nozzle adapted to deliver a jet of fluid at the rear screen,
the pump being a two-way pump adapted to be driven in two opposite directions of rotation to supply one or other of the nozzles, under the control of said switch, characterized in that means for generating electrical control signals linked to the drive motor are adapted to generate electrical control signals which vary according to the angular position of the wiper arm on the glazed surface, and in that said two-way pump is powered in the first position of the switch via the electrical control signal generating means connected to the drive motor, according to the angular position of the wiper arm on the glazed surface.

Thus the electrical control circuit for powering the two-way pump is simplified, and the wiper system is less costly.

The wiper system may also have one or more of the following characteristics, considered individually or in combination:

Said screen wash system may comprise a selective electrical component for powering the two-way pump in the first position of the switch, via the electrical control signal generating means connected to the drive motor, according to the angular position of the wiper arm on the glazed surface, and for shunting said generating means in the second position.

Said selective electrical component comprises, for example, an electrical bypass line connected in parallel with said generating means and a diode connected in the electrical bypass line.

According to one aspect, the polarization of said diode is selected so as to be in the blocking state in the first position and in the conducting state in the second position of the switch.

According to another aspect, the system comprises a first electrical line directly connecting a first output of the switch to said two-way pump, and a second electrical line connecting a second output of the switch to said two-way pump, via an input and output of the generating means, the electrical bypass line being arranged for the direct connection of the input and output of the generating means.

Said selective electrical component may comprise an electrical relay.

The system may comprise a first electrical line directly connecting a first output of the switch to said two-way pump, and a second electrical line connecting a second output of the switch to said two-way pump, via an input and output of said relay, the relay having a control input connected to an output of the generating means so that the relay can be made to switch between a closed position in which the two-way pump delivers a jet of fluid and an open position which interrupts the delivery of a jet of fluid.

According to another aspect, the relay is made to switch by the activation of a coil which actuates a switch.

Said generating means comprise, for example, a surface forming a cam rotationally and concentrically connected to the shaft of the drive motor, and fixed cam follower means adapted to interact with said cam according to the angular positions occupied by said cam, said generating means being thus adapted to deliver to the follower means two electrical control signals, each varying according to the angular position of the wiper arm on the glazed surface, namely a first electrical control signal used to define an angular aperture in which the drive motor is rotating and to cause the motor to stop in a fixed stop position of the arm, and a second electrical control signal for determining the periods in which the two-way pump of the screen wash system is to be actually operated.

The cam-forming surface comprises, for example, conductive tracks in the form of an arc, and the fixed follower means are sliding contacts which may or may not come into electrical contact with the conductive tracks, according to the angular positions occupied by said cam.

The switch may comprise a double switch.

Other advantages and features of the invention will be apparent from a perusal of the description of the invention and the attached drawings, in which:

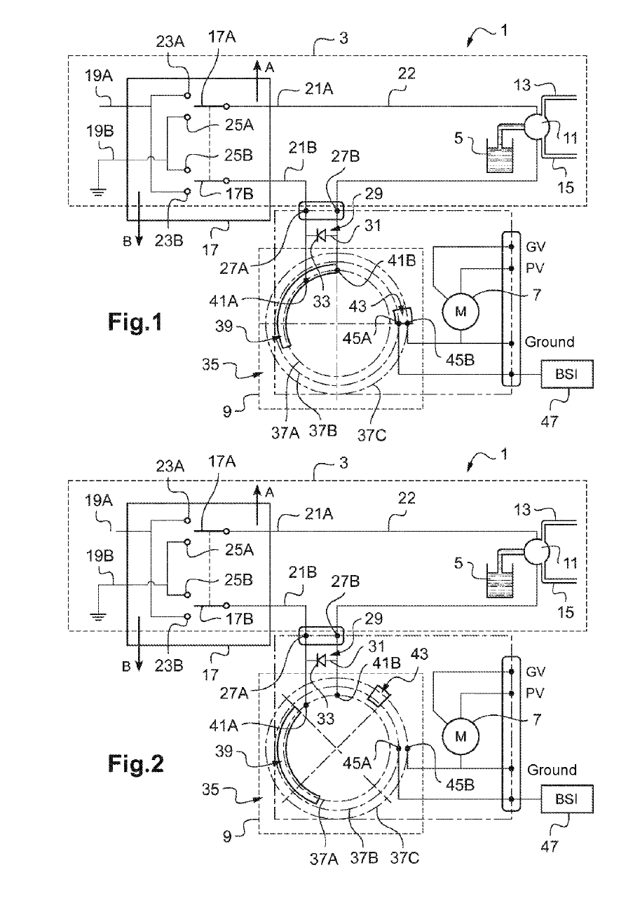

FIG. 1 is a schematic representation of a wiper system according to the invention, in a first embodiment, with a first angular position of a drive motor of a wiper arm,

FIG. 2 is a schematic representation of the wiper system of FIG. 1 with a second angular position of the drive motor of the wiper arm,

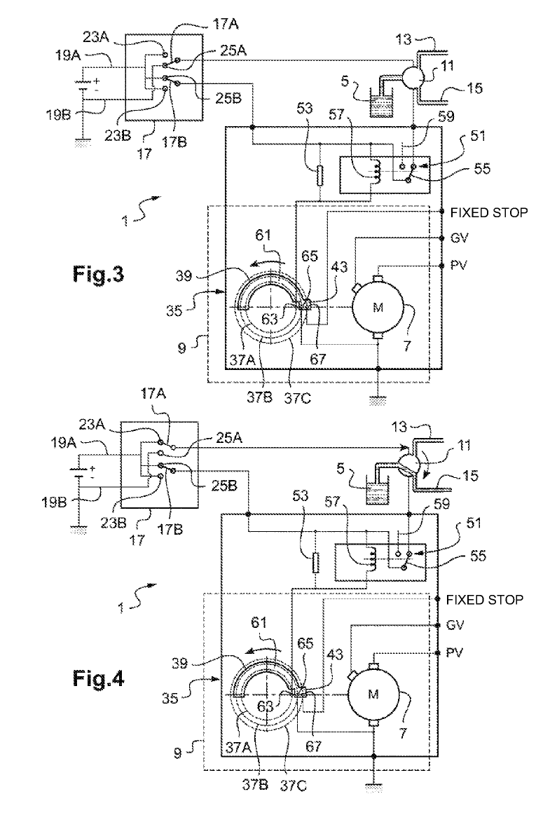

FIGS. 3 to 7 are schematic representations of a wiper system according to the invention, in a second embodiment, in various operating situations.

In these drawings, identical elements are given the same reference numerals.

An example of a first embodiment of a wiper system 1 for a glazed surface of a motor vehicle will now be described with reference to FIGS. 1 and 2.

This system 1 comprises a screen wash system 3 adapted to be used in association with a reservoir 5 containing a washing fluid.

The wiper system 1 comprises a motor 7 for driving at least one wiper arm (not shown), in particular a wiper arm located at the windshield.

The system 1 also comprises means 9 for generating electrical control signals linked to the drive motor 7 and adapted to generate electrical control signals which vary according to the angular position of the wiper arm on the glazed surface, that is to say the windshield in the present case.

The screen wash system 3 comprises a two-way pump 11 which is fluidly connected, on the one hand, to said reservoir 5, and, on the other hand, via two delivery lines 13 and 15 to at least two nozzles respectively (not shown). The delivery line 13 is connected to a nozzle adapted to deliver a jet of fluid at the windshield of a vehicle, and the delivery line 15 is connected to a nozzle adapted to deliver a jet of fluid at the rear screen of the vehicle. The direction of rotation of the two-way pump 11 determines which of the two delivery lines 13 and 15 is supplied, and therefore determines the nozzle, at the windshield or at the rear window, to which a jet of washing fluid is delivered. The screen wash system 3 further comprises a switch 17, for example a double switch formed by two individual switches 17A/17B which are linked, that is to say move simultaneously in one direction.

In this exemplary embodiment, the switch 17 comprises two inputs 19A and 19B, of which one is connected to a positive terminal and the other is connected to the ground and two outputs 21A and 21B.

The positive terminal 19A is divided into a fork of external contacts 23A and 23B, and the ground terminal 19B is divided into a fork of internal contacts 25A and 25B.

The switches 17A and 17B have three possible positions:
A neutral position as shown in FIG. 1, in which they are not in contact with the external contacts 23A, 23B or the internal contacts 25A and 25B. In this position, no current is supplied to the pump 11.
A lower position, or first position, (indicated by the arrow B) in which the switch 17A is in contact with the contact 25A and the switch 17B is in contact with the contact 23B. In this case, the positive input terminal 19A is connected to the output terminal 21B and the terminal 21A is connected to the ground. This position is specified, for example, for activating the pump 11 in a first direction of rotation for delivering a jet of fluid onto the windshield via the delivery line 13.
An upper position, or second position, (indicated by the arrow A) in which the switch 17A is in contact with the contact 23A and the switch 17B is in contact with the contact 25B. In this case, the positive input terminal 19A is connected to the output terminal 21A and the terminal 21B is connected to the ground. This position is specified, for example, for activating the pump 11 in an inverse direction of rotation for delivering a jet of fluid onto the rear window via the delivery line 15.

The terminal 21A is connected via a first electrical line 22 to an input terminal of the two-way pump 11, and the terminal 21B is connected to a first connecting terminal 27A. A second connecting terminal 27B is connected to the other input terminal of the two-way pump 11. The two connecting terminals 27A and 27B are connected to the electrical control signal generating means 9.

The screen wash system further comprises a selective electrical component 29 for powering the two-way pump in the first position of the switch 17, via the electrical control signal generating means 9 connected to the drive motor 7, according to the angular position of the wiper arm on the glazed surface, and for shunting said generating means 9 in the second position.

In the present exemplary embodiment, said selective electrical component 29 comprises an electrical bypass line 31 connected in parallel with said generating means 9 and a diode 33 connected in the electrical bypass line 31. More precisely, the electrical bypass line 31 is arranged for the direct connection of the input and output, that is to say the terminals 27A and 27B, of the generating means 9.

The polarization of the diode 33 is selected so as to be in the blocking state in the first position and in the conducting state in the second position of the switch 17.

By way of example, said generating means 9 comprise a surface 35 forming a cam rotationally and concentrically linked to the shaft of the drive motor 7. In the present case, this surface is a disk with three concentric tracks 37A, B and C.

The first, innermost, track 37A comprises a conductive track 39 in the form of an arc.

A first and a second sliding contact 41A and 41B, connected to the terminals 27A and 27B respectively, are arranged at a certain distance from one another on this first track 37A.

Thus, when the two sliding contacts 41A and 41B are simultaneously in contact with the conductive track 39, an electrical connection is established between the terminals 27A and 27B.

A small conductive segment 43 straddles the outermost tracks 37B and C.

A third sliding contact 45A is placed facing the track 37B and connected to a built-in systems interface (BSI) 47, and a fourth sliding contact 45B is placed facing the track 37C and is connected to the ground.

When the two sliding contacts 45A and B are both on the conductive segment 43, the BSI 47 is connected to the ground, identifying a stop signal for the drive motor 7.

The drive motor 7 is connected to two power supply terminals PV and GV and to the ground.

The wiper system 1 operates in the following manner: When the switch 17 is in the neutral position, whether or not the drive motor 7 is powered, the two-way pump 11 is not powered, and no jet of washing fluid is delivered.

When the switch 17 is in its upper or second position (indicated by the arrow A), regardless of whether the drive motor 7 is powered and regardless of the position of the cam 35, the electric current flows through the pump 11 and through the bypass 31 and the diode 33, so that a jet of washing fluid is delivered onto the rear window via the delivery line 15. This is because, in this position of the switch 17, the diode 33 is in the conductive state.

Conversely, when the switch 17 is in its lower or first position (indicated by the arrow B), the current can no longer flow through the bypass 31, since the diode 33 is in the blocking state in this polarization.

In this case, the pump 11 can only be powered through the generating means 9, more specifically when the two sliding contacts 41A and 41B are simultaneously in contact with the conductive track 39 (as shown in FIG. 1). In this case, an electrical connection having a polarization which is the inverse of that of the second position of the switch 17 can power the pump 11, which therefore rotates in the inverse direction and supplies the windshield via the delivery line 13. In this case, the duration of the delivery of the jet of fluid and the precise instant of the start of delivery depend on the angular position of the cam 35, and therefore on the position of the wiper arm on the glazing.

As shown in FIG. 2, the cam 35 is in a different angular position, and the two sliding contacts 41A and 41B are no longer in contact with the conductive track 39, but with the insulating portion of the first track 37A. In this case, the electrical connection of the pump 11 is interrupted.

FIGS. 3 to 7 show another embodiment, which differs from that of FIGS. 1 and 2 in the following respects: In the neutral position of the switch 17, the switches 17A and 17B are in contact with the electrical contacts 25A and 25B and are therefore connected to the ground. There is no floating potential as in the neutral position of the embodiment of FIG. 1.

Additionally, the selective electrical component 29 comprises an electrical relay 51 which replaces the diode 33 in terms of function.

A resistor 53 is connected in parallel with the relay 51.

The relay 51 has a toggle switch 55 which is held by an elastic force, for example that of a spring, in a position connecting an output of the relay to the two-way pump 11, unless a current is flowing through a coil 57 of the relay. In the latter case, the magnetic force of the coil causes the switch 55 to oscillate to a neutral position, connecting the switch to a floating potential terminal 59.

There is also a difference in relation to the generating means 9. The cam 35 still has three tracks 37A, B and C and a conductive track 39 in the form of an arc, extending through 175° for example.

However, the track 37B now also has a track 61 in the form of an arc parallel to the track 39 and slightly longer than the track 39, extending over 180° for example, to continue into the narrow conductive segment 43 (STOP_PUMP) straddling the outermost tracks 37B and C. This track 61 is electrically connected to the track 39.

One output of the relay connected to the coil 57 is connected to a sliding contact 63 placed facing the track 37A.

A sliding contact 65 placed facing the track 37B is connected to the ground, and a sliding contact 67 placed facing the track 37C is connected to a signal line FIXED_STOP.

In FIG. 3, the switch 17 is in the neutral position. In this case, whether or not the drive motor 7 is powered, the two-way pump 11 is connected to the ground and is therefore not powered, and no jet of washing fluid is delivered.

In FIG. 4, the switch 17 is in its upper or second position, and the electric current flows through the pump 11 and through the relay 51 regardless of whether the drive motor 7 is powered and regardless of the position of the cam 35, so that a jet of washing fluid is delivered onto the rear window via the delivery line 15. This is because the coil 57 is still connected to the ground in this position. Consequently, the relay does not draw any current, and the switch 55 of the relay remains in its position in which it is connected to the pump 11. Thus the relay 51 shunts said generating means 9 in this second position.

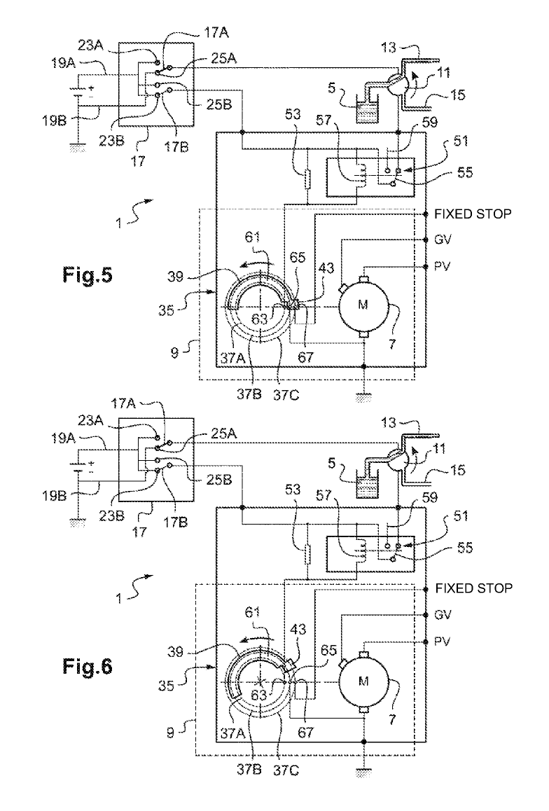

In FIGS. 5 to 7, the switch 17 is in its lower or first position, and three different positions are shown for the cam 35.

In FIG. 5, the drive motor 7 is in the fixed stop position. Consequently, the sliding contact 63 is not in electrical contact with the conductive tracks of the cam 35, and the coil 57 is therefore not powered. In this configuration, the pump 11 is powered in the inverse direction relative to that of the second position of the switch 17, and the windshield nozzle or nozzles are supplied via the delivery line 13.

In FIG. 6, the drive motor 7 has moved by rotating to the left, corresponding to the departure of the wiper arm from its FIXED_STOP position and its upward movement. Since the sliding contact 63 is still on the non-conductive part of the track 37A, the pump is powered, as explained in relation to FIG. 5.

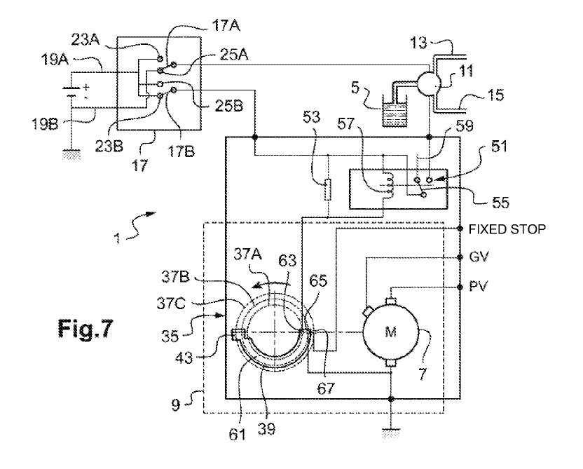

Then, in FIG. 7, the drive motor 7 has reached the position where the movement of the wiper arm is inverted. At this point, the sliding contact 63 is on the track 39, and the sliding contact 65 is on the conductive track 61 and is therefore connected to the ground.

Thus, while the two sliding contacts 63 and 65 are on the conductive tracks 39 and 61 respectively, the coil 57 is powered and therefore oscillates the switch 55 of the relay 51 so as to interrupt the power supply to the pump 11. Consequently the pump is unpowered during the whole of the return movement of the wiper arm toward the FIXED_STOP position.

It should be noted that this circuit is advantageous in energy terms, because the coil 57 of the relay is powered only during the return movement of the wiper arm.

Clearly, therefore, the present invention makes it possible to combine a two-way pump 11 of a screen wash system, for supplying a rear screen and the windshield, with electrical control signal generating means 9 linked to the drive motor 7 and adapted to generate electrical control signals which vary according to the angular position of the wiper arm on the glazed surface.

1. A wiper system for a glazed surface of a motor vehicle including a screen wash system adapted to be used in association with a reservoir containing a washing fluid, said wiper system comprising:
a motor for driving at least one wiper arm;
a pump to be fluidly connected to said reservoir and to at least two nozzles, at least one of which is configured to deliver a jet of fluid at the windshield of a vehicle and at least another of which is configured to deliver a jet of fluid at the rear screen of a vehicle;
a switch having at least a first position for supplying said at least one nozzle configured to deliver a jet of fluid at the windshield, and a second position for supplying said at least one nozzle configured to deliver a jet of fluid at the rear screen,
the pump being a two-way pump configured to be driven in two opposite directions of rotation to supply one or another of the nozzles, under the control of said switch; and
means for generating electrical control signals linked to the drive motor configured to generate electrical control signals which vary according to the angular position of the wiper arm on the glazed surface,
wherein said two-way pump is powered in the first position of the switch via the electrical control signal generating means connected to the drive motor, according to the angular position of the wiper arm on the glazed surface.

2. The wiper system as claimed in claim 1, wherein the screen wash system further comprises a selective electrical component for powering the two-way pump in the first position of the switch, via the electrical control signal generating means connected to the drive motor, according to the angular position of the wiper arm on the glazed surface, and for shunting said generating means in the second position.

3. The wiper system as claimed in claim 2, wherein said selective electrical component comprises an electrical bypass line connected in parallel with said generating means and a diode connected in the electrical bypass line.

4. The wiper system as claimed in claim 3, wherein the polarization of said diode is selected to be in the blocking state in the first position and in the conducting state in the second position of the switch.

5. The wiper system as claimed in claim 3, further comprising a first electrical line directly connecting a first output of the switch to said two-way pump, and a second electrical line connecting a second output of the switch to said two-way pump, via an input and output of the generating means, the electrical bypass line being arranged for the direct connection of the input and output of the generating means.

6. The wiper system as claimed in claim 1, wherein said selective electrical component comprises an electrical relay.

7. The wiper system as claimed in claim 6, further comprising:
a first electrical line directly connecting a first output of the switch to said two-way pump; and
a second electrical line connecting a second output of the switch to said two-way pump, via an input and output of said relay,
the relay having a control input connected to an output of the generating means so that the relay is able to switch between a closed position in which the two-way pump delivers a jet of fluid and an open position which interrupts the delivery of a jet of fluid.

8. The wiper system as claimed in claim 7, wherein the relay is made to switch by the activation of a coil which actuates a switch.

9. The wiper system as claimed in claim 1, wherein said generating means comprise:
a surface forming a cam rotationally and concentrically connected to the shaft of the drive motor, and
fixed cam follower means configured to interact with said cam according to the angular positions occupied by said cam,
wherein said generating means are configured to deliver to the follower means two electrical control signals, each varying according to the angular position of the wiper arm on the glazed surface,
the two electrical control signals comprising a first electrical control signal used to define an angular aperture in which the drive motor is rotating and to cause the motor to stop in a fixed stop position of the arm, and a second electrical control signal for determining the periods in which the two-way pump of the screen wash system is to be actually operated.

10. The wiper system as claimed in claim 9, wherein the cam-forming surface comprises conductive tracks in the form of an arc, and the fixed follower means are sliding contacts which come into electrical contact with the conductive tracks, according to the angular positions occupied by said cam.

11. The wiper system as claimed in claim 1, wherein the switch comprises a double switch.
